(19) United States
(12) Patent Application Publication
(10) Pub. No.: US 2022/0318734 A1
(43) Pub. Date: Oct. 6, 2022

(54) MANAGEMENT PROGRAM AND MANAGEMENT METHOD

(71) Applicant: BROTHER KOGYO KABUSHIKI KAISHA, Nagoya (JP)

(72) Inventor: Takeshi Nagasaki, Nagoya (JP)

(21) Appl. No.: 17/709,476

(22) Filed: Mar. 31, 2022

(30) Foreign Application Priority Data
Mar. 31, 2021 (JP) 2021-060263

(51) Int. Cl. G06Q 10/08; B41J 2/175; G06Q 20/14

(52) U.S. Cl. CPC G06Q 10/087; B41J 2/17566; B41J 2/17546; G06Q 10/083; G06Q 20/145; B41J 2002/17589

(57) ABSTRACT

A non-transitory computer readable medium stores a management program causing a controller to execute a process for controlling a management device of a management system in which a printer to which a cartridge containing a color material is mountable and the management device are communicable with each other. The process includes receiving a service start request, receiving, from the printer, cartridge type information and cartridge remaining amount information, determining whether the cartridge mounted in the printer is a service available cartridge, shipping a service available cartridge in a case where it is determined that the mounted cartridge is not the service available cartridge, further determining whether a shipping condition is satisfied based on the received cartridge remaining amount information, and shipping a service available cartridge in a case where it is determined that the shipping condition is satisfied in the further determining.

### CROSS REFERENCE TO RELATED APPLICATIONS

This application is based on Japanese Patent Applications No. 2021-060263 filed on Mar. 31, 2021, the entire contents of which are incorporated herein by reference.

### BACKGROUND

The present disclosure relates to a technique for managing a printer.

JP-A-2016-193592 discloses an information management server that provides a flat-rate printing service to a user of a printer. When a contract of the flat-rate printing service is concluded with the user of the printer, the information management server executes a processing for shipping a dedicated cartridge for the flat-rate printing service to the user of the printer.

The technique described in JP-A-2016-193592 does not consider a situation in which a user of a printer may have a dedicated cartridge before the contract of the flat-rate printing service with the user of the printer is concluded. Therefore, regardless of whether the user of the printer has had a dedicated cartridge, a dedicated cartridge is shipped to the user. As a result, the user may have two or more cartridges.

An object of the present disclosure is to prevent the occurrence of a situation in which a user of a printer possesses such an unnecessary cartridge.

### SUMMARY

According to an aspect of the present disclosure, a non-transitory computer readable medium stores a management program causing a controller to execute a process for controlling a management device of a management system in which a printer to which a cartridge containing a color material is mountable and the management device are communicable with each other. The process includes receiving a service start request that requests a start of a shipping service for shipping the cartridge for the printer, receiving, from the printer, cartridge type information indicating a type of the cartridge mounted in the printer and cartridge remaining amount information indicating a remaining amount of the color material in the cartridge, determining whether the cartridge mounted in the printer is a service available cartridge that is available for the shipping service based on the cartridge type information received from the printer, in a case where the service start request is received, shipping a service available cartridge in a case where it is determined that the mounted cartridge is not the service available cartridge in the determining, further determining whether a shipping condition is satisfied based on the received cartridge remaining amount information, in a case where it is determined that the mounted cartridge is the service available cartridge in the determining, and shipping a service available cartridge in a case where it is determined that the shipping condition is satisfied in the further determining.

According to another aspect of the present disclosure, a non-transitory computer readable medium stores a management program causing a controller to execute a process for controlling a management device of a management system in which a printer to which a plurality of color cartridges containing color material different to each other is mountable and the management device are communicable with each other. The process includes receiving a service start request that requests a start of a shipping service for shipping the plurality of color material cartridges for the printer, receiving, from the printer, color material cartridge type information indicating types of the color material cartridges mounted in the printer and color material cartridge remaining amount information indicating remaining amounts of the color materials in the color material cartridges, determining whether at least one of the color material cartridges mounted in the printer is a service available cartridge available for the shipping service based on the received color material cartridge type information, in a case where the service start request is received, shipping a service available cartridge containing a color material corresponding to one of the mounted color material cartridges in a case where it is determined that the one of the mounted color material cartridges is not the service available cartridge in the determining, further determining whether a shipping condition for the one of the mounted color material cartridges is satisfied based on the received color material cartridge remaining amount information, in a case where it is determined that the one of the mounted color material cartridge is the service available cartridge in the determining; and shipping a service available cartridge containing a color material corresponding to the one of the mounted color material cartridges in a case where it is determined that the shipping condition is satisfied in the further determining.

### BRIEF DESCRIPTION OF DRAWINGS

FIG. 1 is a diagram showing a configuration of a management system.

FIG. 2 is a block diagram showing a configuration of a terminal device, a printer, and a service server.

FIG. 3 is a sequence diagram showing a procedure of applying for a printing service.

FIG. 4 is a flowchart showing a first part of a service start processing.

FIG. 5 is a flowchart showing a second part of the service start processing.

FIG. 6 is a flowchart showing a third part of the service start processing.

### DESCRIPTION OF EMBODIMENTS

Hereinafter, embodiments of the present disclosure will be described with reference to the drawings.

(1) Configuration of Management System 1

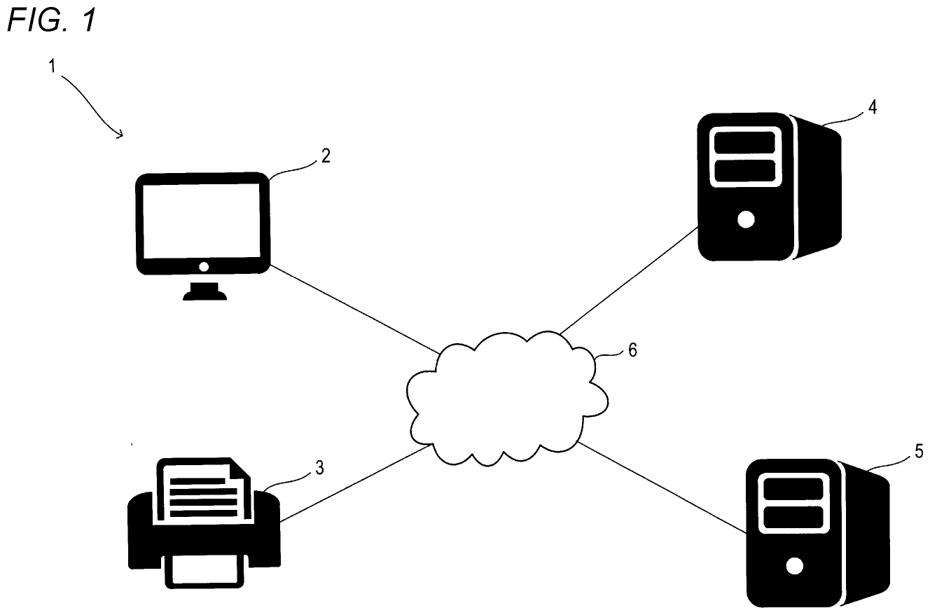

The management system 1 according to the present embodiment is a system that manages a printing service. As shown in FIG. 1, the management system 1 includes a terminal device 2, a printer 3, a service server 4, and a shipping server 5.

A printing service includes a shipping service for automatically delivering a cartridge that is mountable to the printer 3, and a charging service for charging according to the number of print media on which the printer 3 performs printing. The charging service is a service for charging a fee at a flat-rate when the number of print media is equal to or less than the number of print media specified for each service plan (hereinafter, referred to as the specified number of print media) in a service unit period (for example, one month), and charging an additional fee for printing when the number of print media exceeds the specified number of print media. When the number of print media in the service unit period is less than the specified number of print media, the difference is carried over to a subsequent service unit period.

The terminal device 2, the printer 3, the service server 4, and the shipping server 5 are communicable with one another via a WAN 6. WAN stands for wide area network. The WAN 6 according to the present embodiment is the Internet.

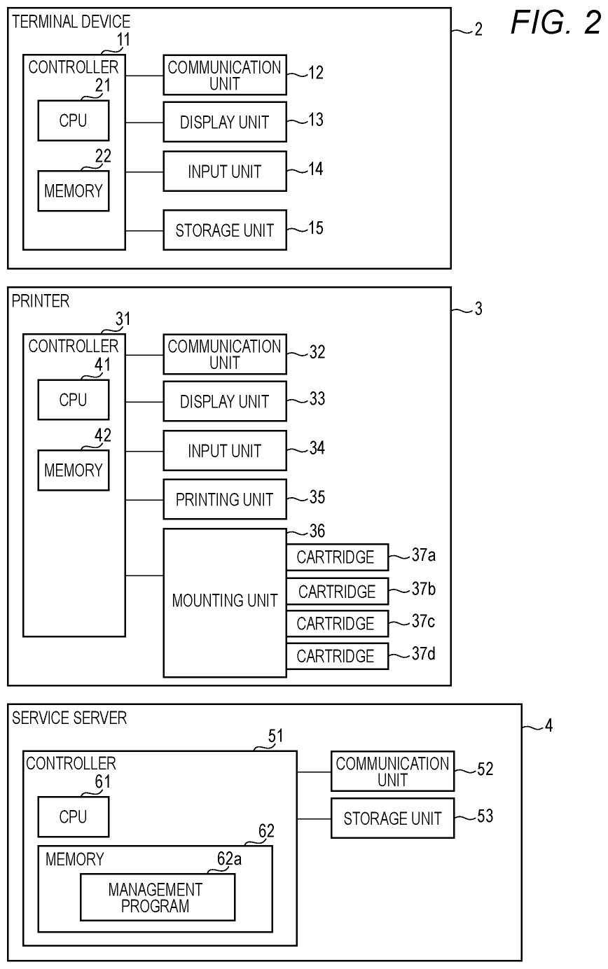

The terminal device 2 is a personal computer in the present embodiment. As shown in FIG. 2, the terminal device 2 includes a controller 11, a communication unit 12, a display unit 13, an input unit 14, and a storage unit 15. The terminal device 2 may be a mobile terminal including a smartphone or a tablet.

The controller 11 includes a CPU 21 and a memory 22. The CPU 21 executes a program stored in the memory 22, thereby implementing various functions of the terminal device 2. The various functions implemented by the controller 11 are not limited to those implemented by executing the program, and a part or all of the functions may be implemented by using one or a plurality of pieces of hardware.

The memory 22 includes a semiconductor memory (for example, a ROM, a RAM, and a flash memory) that is a non-transitory tangible recording medium. The communication unit 12 executes data communication with the service server 4 via the WAN 6.

The display unit 13 includes a display device (not shown), and displays various images on the display device. The input unit 14 includes a keyboard and a mouse. The input unit 14 outputs input operation information for specifying an input operation performed by a user of the terminal device 2 using the keyboard and the mouse.

The storage unit 15 includes, for example, an auxiliary storage device including an HDD or an SSD, and stores various types of data. HDD stands for Hard Disk Drive. SSD stands for Solid State Drive.

The printer 3 includes a controller 31, a communication unit 32, a display unit 33, an input unit 34, a printing unit 35, and amounting unit 36. The controller 31 includes a CPU 41 and a memory 42. The CPU 41 executes a program stored in the memory 42, thereby implementing various functions of the printer 3. The various functions implemented by the controller 31 are not limited to those implemented by executing the program, and a part or all of the functions may be implemented by using one or a plurality of pieces of hardware. The memory 42 includes a semiconductor memory (for example, a ROM, a RAM, and a flash memory) that is a non-transitory tangible recording medium, and stores a program and data.

The communication unit 32 executes data communication with the service server 4 via the WAN 6. The display unit 33 includes a display device (not shown), and displays various images on the display device. The input unit 34 includes a touch panel provided on a display screen of the display unit 33 and switches provided around the display screen of the display unit 33. The input unit 34 outputs input operation information for specifying an input operation performed by a user via the touch panel and the switches.

The printing unit 35 has a printing mechanism of an inkjet technique or an electrophotographic technique, and is configured to print an image on a print medium. A first cartridge 37a, a second cartridge 37b, a third cartridge 37c, and a fourth cartridge 37d are mounted in the mounting unit 36 in a detachable manner. The first, second, third, and fourth cartridges 37a to 37d contain color materials (ink in the present embodiment) to be attached to a print medium by the printing unit 35 in order to print an image on the print medium. Each of the first, second, third, and fourth cartridges 37a, 37b, 37c, and 37d contains corresponding one of color materials of cyan, magenta, yellow, and black.

The service server 4 includes a controller 51, a communication unit 52, and a storage unit 53. The controller 51 includes a CPU 61 and a memory 62. The CPU 61 executes a program stored in the memory 62, thereby implementing various functions of the service server 4. The various functions implemented by the controller 51 are not limited to those implemented by executing the program, and a part or all of the functions may be implemented by using one or a plurality of pieces of hardware. The memory 62 includes a semiconductor memory (for example, a ROM, a RAM, and a flash memory) that is a non-transitory tangible recording medium, and stores a program and data.

The memory 62 stores a management program 62a. The management program 62a is a computer program for causing the CPU 61 to implement a function of managing the printing service. The communication unit 52 executes data communication with the terminal device 2, the printer 3, and the shipping server 5 via the WAN 6. The storage unit 53 includes, for example, an auxiliary storage device including an HDD or an SSD, and stores various types of data.

When the shipping server 5 receives a cartridge shipping instruction to be described later from the service server 4, the shipping server 5 notifies a shipping operator to perform a cartridge shipment according to contents of the cartridge shipping instruction. As a result, a cartridge is shipped in accordance with the cartridge shipping instruction.

(2) Applying for Printing Service

Next, a procedure when an owner of the printer 3 (hereinafter, referred to as a service user) applies for a printing service will be described.

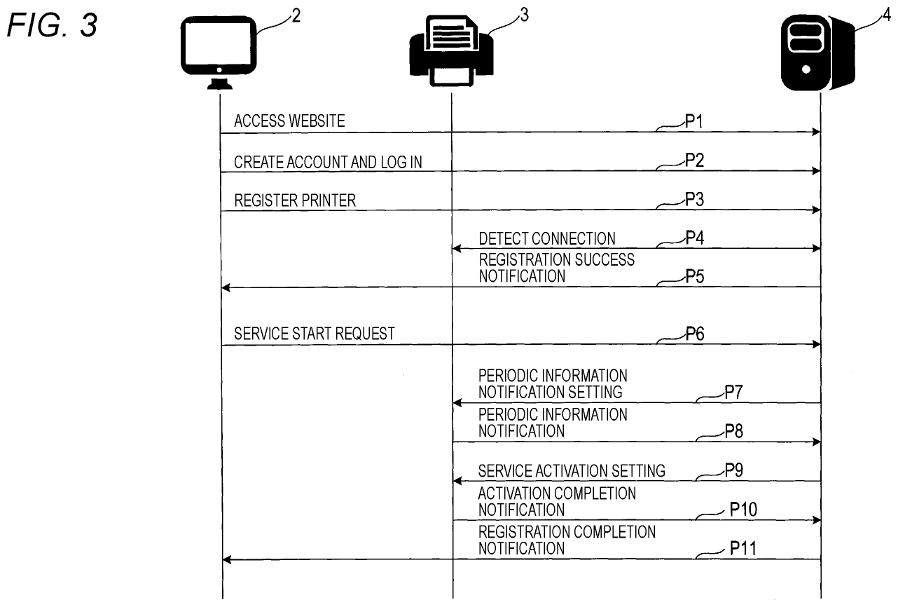

First, when the service user performs an input operation on the terminal device 2 via the input unit 14, the terminal device 2 accesses a website (hereinafter, referred to as a service website) provided by the service server 4 for providing a printing service, as shown in a processing P1 in FIG. 3.

Further, w % ben the service user performs an input operation on the terminal device 2, the terminal device 2 creates an account for using the printing service and logs in to the service website as shown in a processing P2. The account is created by registering at least one of a name, an mail address, or a password of the service user.

Next, when the service user performs an input operation on the terminal device 2, the terminal device 2 registers the printer 3 in the service website as shown in a processing P3. Specifically, the terminal device 2 transmits printer identification information for specifying the printer 3 to the service server 4.

When the service server 4 receives the printer identification information, the service server 4 communicates with the printer 3 via the WAN 6 and detects the printer 3 according to the printer identification information, as shown in a processing P4.

When the service server 4 detects the printer 3, the service server 4 registers the printer 3 as a registered printer for the account of the service user, and transmits a registration success notification indicating that the registration is successful to the terminal device 2 as shown in a processing P5.

Next, when the service user performs an input operation on the terminal device 2, the terminal device 2 transmits, to the service server 4, a service start request for applying for a printing service of the registered printer, as shown in a processing P6. The service start request includes plan information indicating a type of a plan of the applied printing service, delivery destination information indicating a delivery destination of a cartridge, and payment information (for example, a credit card number) for charging a usage fee for the printing service.

When the service server 4 receives the service start request, the service server 4 executes periodic information notification setting to cause the printer 3 to transmit notification information periodically (for example, every 12 hours), as shown in a processing P7. The notification information includes firmware identification information, page count information, consumable item remaining amount information, replacement count information, and cartridge type information.

The firmware identification information indicates a type and a version of the firmware of the printer 3. The page count information indicates the number of print media used by the printer 3. The consumable item remaining amount information indicates remaining amounts of color materials of the first, second, third, and fourth cartridges 37a, 37b, 37c, and 37d. The replacement count information indicates the number of times of replacements of the first, second, third, and fourth cartridges 37a, 37b, 37c, and 37d.

The cartridge type information indicates whether the cartridges 37a to 37d are a commercially available cartridge, a packaged cartridge, or a service dedicated cartridge. The commercially available cartridge is a cartridge that is purchaseable in a store. The packaged cartridge is a cartridge that is packaged with the printer 3 when the printer 3 is purchased. The service dedicated cartridge is a cartridge dedicated to a printing service.

Hereinafter, service dedicated cartridges corresponding to the first, second, third, and fourth cartridges 37a, 37b. 37c, and 37d are referred to as first, second, third, and fourth service dedicated cartridges. When the periodic information notification setting is executed on the printer 3, the printer 3 transmits first notification information to the service server 4 as a periodic information notification as shown in a processing P8.

When the service server 4 receives the notification information, the service server 4 executes service activation setting on the printer 3 as shown in a processing P9. As a result, the printer 3 is set from a normal mode to a service mode.

When the printer 3 transits to the service mode, the printer 3 transmits an activation completion notification to the service server 4 as shown in a processing P10. When the service server 4 receives the activation completion notification, the service server 4 transmits a registration completion notification to the terminal device 2 as shown in a processing P11. As a result, the service user recognizes that the application for the printing service is completed.

(3) Processing Executed in Service Server 4

Next, a procedure of a service start processing executed by the CPU 61 of the service server 4 will be described. The service start processing is a processing repeatedly executed during the operation of the controller 51.

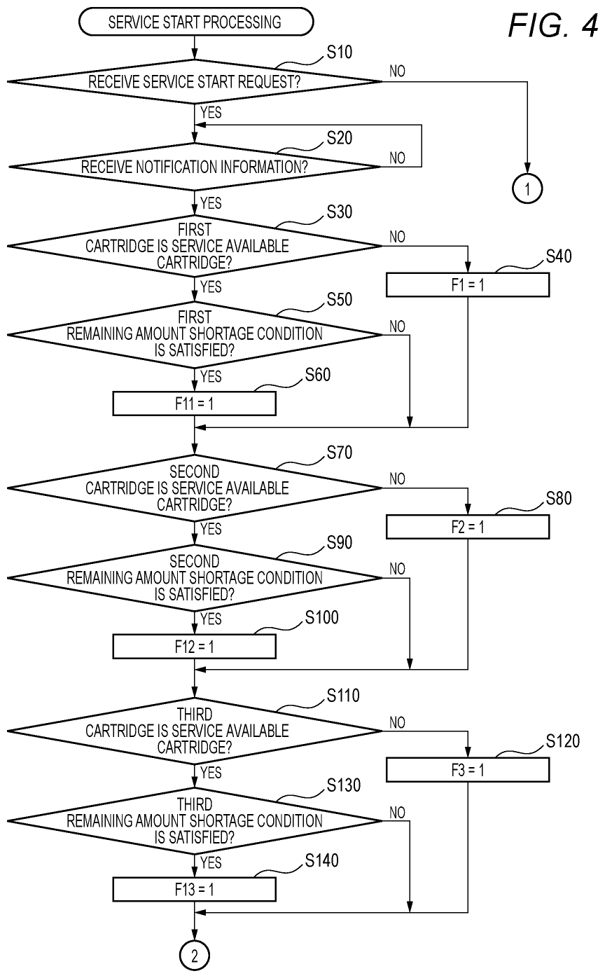

When the service start processing is executed, as shown in FIG. 4, the CPU 61 first determines whether a service start request is received in 510. When the service start request is not received, the CPU 61 ends the service start processing.

On the other hand, when the service start request is received, in S20, the CPU 61 determines whether notification information is received from the registered printer registered in the account (hereinafter, referred to as a service target account) from which the service start request is sent.

When the notification information is not received from the registered printer, the CPU 61 repeats the processing in S20 until the notification information is received from the registered printer. When the notification information is received from the registered printer, in S30, the CPU 61 determines whether the first cartridge 37a is a service available cartridge based on cartridge type information included in the notification information received in S20. The service available cartridge includes a packaged cartridge and a service dedicated cartridge.

Here, when the first cartridge 37a is not a service available cartridge, the CPU 61 sets a first service non-available flag F1 provided in the memory 62 in S40, and proceeds the processing to S70. Setting a flag indicates that a value of the flag is set to 1, and clearing a flag indicates that a value of the flag is set to 0.

On the other hand, when the first cartridge 37a is the service available cartridge, in S50, the CPU 61 determines whether a first remaining amount shortage condition set in advance is satisfied based on consumable item remaining amount information included in the notification information received in S20. The first remaining amount shortage condition according to the present embodiment is a condition in which a remaining amount of a color material of the first cartridge 37a is equal to or less than a first shortage threshold set in advance.

When the first remaining amount shortage condition is not satisfied, the CPU 61 proceeds the processing to S70. On the other hand, when the first remaining amount shortage condition is satisfied, the CPU 61 sets a first shortage flag F11 provided in the memory 62 in S60, and proceeds the processing to S70.

In S70, the CPU 61 determines whether the second cartridge 37b is a service available cartridge based on the cartridge type information included in the notification information received in S20.

Here, when the second cartridge 37b is not a service available cartridge, the CPU 61 sets a second service non-comtible flag F2 provided in the memory 62 in S80, and proceeds the processing to S110.

On the other hand, when the second cartridge 37b is the service available cartridge, in S90, the CPU 61 determines whether a second remaining amount shortage condition set in advance is satisfied based on the consumable item remaining amount information included in the notification information received in S20. The second remaining amount shortage condition according to the present embodiment is a condition in which a remaining amount of a color material of the second cartridge 37b is equal to or less than a second shortage threshold set in advance.

When the second remaining amount shortage condition is not satisfied, the CPU 61 proceeds the processing to S110. On the other hand, when the second remaining amount shortage condition is satisfied, the CPU 61 sets a second shortage flag F12 provided in the memory 62 in S100, and proceeds the processing to S110.

In S110, the CPU 61 determines whether the third cartridge 37c is a service available cartridge based on the cartridge type information included in the notification information received in S20.

Here, when the third cartridge 37c is not a service available cartridge, the CPU 61 sets a third service non-comtible flag F3 provided in the memory 62 in S120, and proceeds the processing to S150.

On the other hand, when the third cartridge 37c is the service available cartridge, in S130, the CPU 61 determines whether a third remaining amount shortage condition set in advance is satisfied based on the consumable item remaining amount information included in the notification information received in S20. The third remaining amount shortage condition according to the present embodiment is a condition in which a remaining amount of a color material of the third cartridge 37c is equal to or less than a third shortage threshold set in advance.

When the third remaining amount shortage condition is not satisfied, the CPU 61 proceeds the processing to S150. On the other hand, when the third remaining amount shortage condition is satisfied, the CPU 61 sets a third shortage flag F13 provided in the memory 62 in S140, and proceeds the processing to S150.

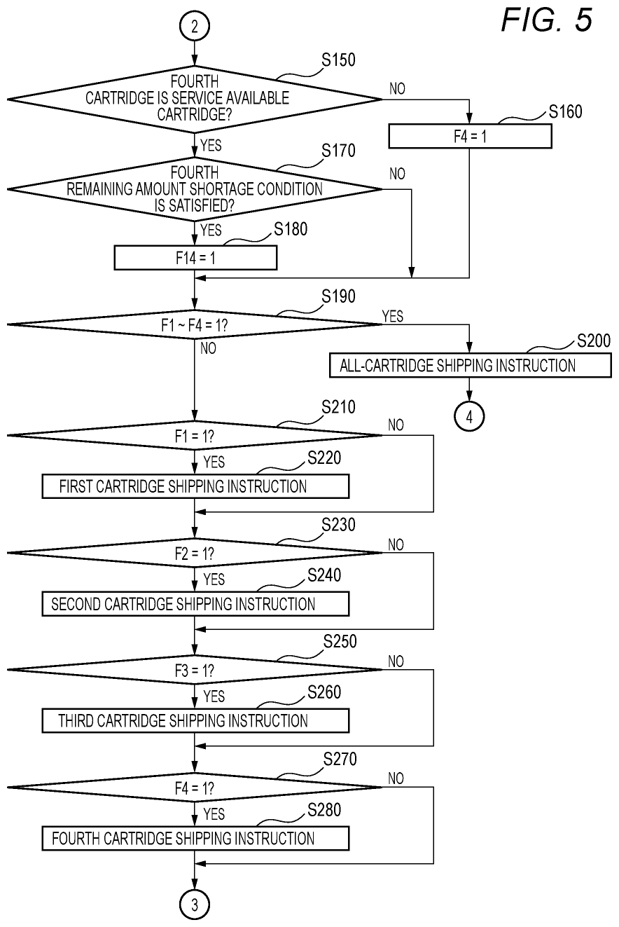

In S150, the CPU 61 determines whether the fourth cartridge 37d is a service available cartridge based on the cartridge type information included in the notification information received in S20, as shown in FIG. 5.

Here, when the fourth cartridge 37d is not a service available cartridge, the CPU 61 sets a fourth service non-comtible flag F4 provided in the memory 62 in S160, and proceeds the processing to S190.

On the other hand, when the fourth cartridge 37d is the service available cartridge, in S170, the CPU 61 determines whether a fourth remaining amount shortage condition set in advance is satisfied based on the consumable item remaining amount information included in the notification information received in S20. The fourth remaining amount shortage condition according to the present embodiment is a condition in which a remaining amount of a color material of the fourth cartridge 37d is equal to or less than a fourth shortage shreshold set in advance.

When the fourth remaining amount shortage condition is not satisfied, the CPU 61 proceeds the processing to S190. On the other hand, when the fourth remaining amount shortage condition is satisfied, the CPU 61 sets a fourth shortage flag F14 provided in the memory 62 in S180, and proceeds the processing to S190.

In SIX), the CPU 61 determines whether all of the first service non-comtible flag F1, the second service non-comtible flag F2, the third service non-comtible flag F3, and the fourth service non-comtible flag F4 are set.

Here, when the first to fourth service non-comtible flags F1 to F4 are set, the CPU 61 transmits an all-cartridge shipping instruction to the shipping server 5 in S200, and proceeds the processing to S370. The all-cartridge shipment shipping instruction is an instruction for shipping service dedicated cartridges of all colors (that is, the first, second, third, and fourth service dedicated cartridges) corresponding to the registered printer of the service target account to a delivery destination of the service target account.

When at least one of the first to fourth service non-comtible flags F1 to F4 is cleared in S190, the CPU 61 determines whether the first service non-comtible flag F1 is set in S210. Here, when the first service non-comtible flag F1 is cleared, the CPU 61 proceeds the processing to S230. On the other hand, when the first service non-comtible flag F1 is set, the CPU 61 transmits a first cartridge shipping instruction to the shipping server 5 in S220, and proceeds the processing to S230. The first cartridge shipping instruction is an instruction for shipping the first service dedicated cartridge corresponding to the registered printer of the service target account to a delivery destination of the service target account.

In S230, the CPU 61 determines whether the second service non-comtible flag F2 is set. When the second service non-comtible flag F2 is cleared, the CPU 61 proceeds the processing to S250. On the other hand, when the second service non-comtible flag F2 is set, the CPU 61 transmits a second cartridge shipping instruction to the shipping server 5 in S240, and proceeds the processing to S250. The second cartridge shipping instruction is an instruction for shipping the second service dedicated cartridge corresponding to the registered printer of the service target account to a delivery destination of the service target account.

In S250, the CPU 61 determines whether the third service non-comtible flag F3 is set. When the third service non-comtible flag F3 is cleared, the CPU 61 proceeds the processing to S270. On the other hand, when the third service non-comtible flag F3 is set, the CPU 61 transmits a third cartridge shipping instruction to the shipping server 5 in S260, and proceeds the processing to S270. The third cartridge shipping instruction is an instruction for shipping the third service dedicated cartridge corresponding to the registered printer of the service target account to a delivery destination of the service target account.

In S270, the CPU 61 determines whether the fourth service non-comtible flag F4 is set. When the fourth service non-comtible flag F4 is cleared, the CPU 61 proceeds the processing to S290. On the other hand, when the fourth service non-comtible flag F4 is set, the CPU 61 transmits a fourth cartridge shipping instruction to the shipping server 5 in S280, and proceeds the processing to S290. The fourth cartridge shipping instruction is an instruction for shipping the fourth service dedicated cartridge corresponding to the registered printer of the service target account to a delivery destination of the service target account.

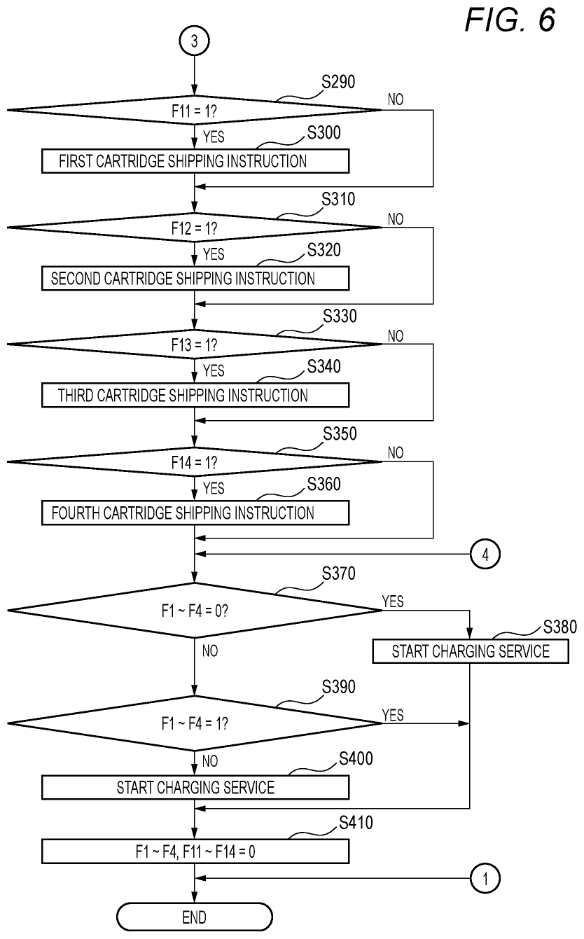

In S290, the CPU 61 determines whether the first shortage flag F11 is set, as shown in FIG. 6. When the first shortage flag F11 is cleared, the CPU 61 proceeds the processing to S310. On the other hand, when the first shortage flag F11 is set, the CPU 61 transmits the first cartridge shipping instruction to the shipping server 5 in S300, and proceeds the processing to S310.

In S310, the CPU 61 determines whether the second shortage flag F12 is set. When the second shortage flag F12 is cleared, the CPU 61 proceeds the processing to S330. On the other hand, when the second shortage flag F12 is set, the CPU 61 transmits the second cartridge shipping instruction to the shipping server 5 in S320, and proceeds the processing to S330.

In S330, the CPU 61 determines whether the third shortage flag F13 is set. When the third shortage flag F13 is cleared, the CPU 61 proceeds the processing to S350. On the other hand, when the third shortage flag F13 is set, the CPU 61 transmits the third cartridge shipping instruction to the shipping server 5 in S340, and proceeds the processing to S350.

In S350, the CPU 61 determines whether the fourth shortage flag F14 is set. When the fourth shortage flag F14 is cleared, the CPU 61 proceeds the processing to S370. On the other hand, when the fourth shortage flag F14 is set, the CPU 61 transmits the fourth cartridge shipping instruction to the shipping server 5 in S360, and proceeds the processing to S370.

In S370, the CPU 61 determines whether all of the first service non-comtible flag F1, the second service non-comtible flag F2, the third service non-comtible flag F3, and the fourth service non-comtible flag F4 are cleared.

Here, when the first to fourth service non-comtible flags F1 to F4 are cleared, the CPU 61 starts a charging service for charging the service target account in S380, and proceeds the processing to S410. On the other hand, when at least one of the first to fourth service non-comtible flags F1 to F4 is set, the CPU 61 determines whether all of the first service non-comtible flag F1, the second service non-comtible flag F2, the third service non-comtible flag F3, and the fourth service non-comtible flag F4 are set in S390.

Here, when the first to fourth service non-comtible flags F1 to F4 are set, the CPU 61 proceeds the processing to S410. On the other hand, when at least one of the first to fourth service non-comtible flags F1 to F4 is cleared, the CPU 61 starts a charging service for charging a fee for the service target account in S400, and proceeds the processing to S410.

In S410, the CPU 61 clears all of the first to fourth service non-comtible flags F1 to F4 and the first to fourth shortage flags F11 to F14, and ends the service start processing.

(4) Effects

In the above configuration, the management system 1 configured such that the printer 3 and the service server 4 are communicable with each other and the service server 4 includes the controller 51. The management program 62a having the above configurations is configured to cause the controller 51 to execute a first reception processing, a second reception processing, a cartridge determination processing, a first shipping processing, a shipping determination processing, and a second shipping processing. The first, second, third, and fourth cartridges 37a, 37b, 37c, and 37d that contain cyan, magenta, yellow, and black color materials are mounted in the printer 3.

In the first reception processing, the service server 4 receives the service start request for requesting the printer 3 to start a printing service including a shipping service for shipping the first to fourth cartridges 37a to 37d from the terminal device 2. In the second reception processing, the service server 4 receives the cartridge type information indicating a type of each of the first to fourth cartridges 37a to 37d mounted in the printer 3 and the consumable item remaining amount information indicating a remaining amount of a color material in each of the first to fourth cartridges 37a to 37d from the printer 3.

In the cartridge determination processing, when the service start request is received, it is determined whether the first to fourth cartridges 37a to 37d mounted in the printer 3 are service available cartridges based on the received cartridge type information.

In the first shipping processing, when it is determined that the first to fourth cartridges 37a to 37d mounted in the printer 3 are not service available cartridges, the first to fourth cartridge shipping instructions of the first to fourth service dedicated cartridges are transmitted to the shipping server 5. As a result, a cartridge shipment of each of the first to fourth cartridge shipping instructions is performed. The first shipping processing includes a preparation processing, an ordering processing, and the like for the shipping.

In the shipping determination processing, when it is determined that the first to fourth cartridges 37a to 37d mounted in the printer 3 are the service available cartridges, it is determined whether the first to fourth remaining amount shortage conditions set in advance are satisfied based on the received consumable item remaining amount information.

In the second shipping processing, when it is determined that the first to fourth remaining amount shortage conditions are satisfied, the first to fourth cartridge shipping instructions of the first to fourth service dedicated cartridges are transmitted to the shipping server 5. As a result, a cartridge shipment corresponding to each of the first to fourth cartridge shipping instructions is performed. The second shipping processing includes a preparation processing, an ordering processing, and the like for the shipping.

Accordingly, in a case where the first to fourth cartridges 37a to 37d mounted in the printer 3 are service available cartridges, the shipping of the first to fourth service available cartridges is avoidable until the first to fourth cartridges 37a to 37d mounted in the printer 3 need to be replaced. Therefore, the occurrence of a situation in which a user of the printer 3 has an extra cartridge.

Further, even when the first to fourth cartridges 37a to 37d mounted in the printer 3 are service available cartridges, it is possible to ship the first to fourth service dedicated cartridges to a user of the printer 3 when the remaining amounts of color materials of the first to fourth cartridges 37a to 37d are small. Accordingly, the management program 62a is configured to cause the service server 4 to determine whether to ship a service available cartridge. Therefore, the management program 62a does not need a shipping determination by a user of the printer 3, and convenience for the user of the printer 3 is improved.

A commercially available cartridge that is purchasable in a store, a packaged cartridge that is packaged with the printer 3, and a service dedicated cartridge dedicated to a printing service are mountable in the printer 3. The service available cartridge includes the packaged cartridge and the service dedicated cartridge. Since the packaged cartridge is the service available cartridge, a user of the printer 3 may use the printer 3 in a state in which a printing service is started without waiting for the arrival of the service dedicated cartridge.

The management program 62a is configured to cause the controller 51 to further execute a first charging start processing. In the first charging start processing, when it is determined that all of the first to fourth cartridges 37a to 37d mounted in the printer 3 are service available cartridges, a charging service for charging a fee for the printing of the printer 3 is started. Accordingly, the management program 62a may start the charging service at an appropriate timing for the usage of the printer 3 by using the service available cartridges of all colors.

The management program 62a is configured to cause the controller 51 to execute a second charging start processing. In the second charging start processing, when it is determined that a part of the first to fourth cartridges 37a to 37d mounted in the printer 3 is a service available cartridge, a charging service for charging a fee for the printing of the printer 3 is started. Accordingly, the management program 62a may start the charging service at an appropriate timing for the usage of the printer 3 by using the service available cartridges of some colors.

The management program 62a is configured to cause the controller 51 to execute an all-cartridge shipment processing. The all-cartridge shipment processing is a processing of transmitting, to the shipping server 5, an all-cartridge shipping instruction of the first to fourth service dedicated cartridges, when it is determined that all of the first to fourth cartridges 37a to 37d mounted in the printer 3 are not the service available cartridges. Accordingly, since the management program 62a instructs the shipping of the service available cartridges of all colors together, the efficiency of a shipping operation is improved.

The present disclosure is not limited to the embodiment described above and may be implemented in various modifications.

For example, the service server 4 is a single physical server in the embodiment. Alternatively, the service server 4 may include a plurality of physical servers. The service server 4 may be configured by at least one of a plurality of virtual servers constructed by dividing one physical server by virtualization software.

In the embodiment described above, the first to fourth remaining amount shortage conditions are a condition in which a remaining amount of the color material in each of the first to fourth cartridges 37a to 37d is equal to or less than the first to fourth shortage threshold. Alternatively, the time until the remaining amount of the color material becomes 0 may be determined based on a decreasing tendency of the remaining amount of the color material of each of the first to fourth cartridges 37a to 37d, and when this time is short, it may be determined that the first to fourth remaining amount shortage conditions are satisfied.

The printer according to the present disclosure is the printer 3 in the embodiment described above. Alternatively, the printer according to the present disclosure includes a multifunction device, a copier, and a facsimile that have a scanner function of reading an image from a document. The printer is not limited to an inkjet printer, and may be a laser printer or an LED printer. The LED printer refers to a printer in which a unit for exposing a photosensitive member is an LED head. In this case, a color material is a toner.

A plurality of functions of one constituent element in the embodiment described above may be implemented by a plurality of constituent elements, or one function of one constituent element may be implemented by a plurality of constituent elements. A plurality of functions of a plurality of constituent elements may be implemented by one constituent element, or one function to be implemented by a plurality of constituent elements may be implemented by one constituent element. A part of the configurations in the embodiment described above may be omitted. At least a part of the configurations in the embodiment described above may be added to or replaced with configurations of another embodiment.

In addition to the service server 4 described above, the present disclosure may be implemented in various forms such as a system including the service server 4 as a constituent element, a program for causing a computer to function as the service server 4, a non-transitory tangible recording medium including a semiconductor memory in which the program is recorded, and a management method.

What is claimed is:

1. A non-transitory computer readable medium storing a management program causing a controller to execute a process for controlling a management device of a management system in which a printer to which a cartridge containing a color material is mountable and the management device are communicable with each other, the process comprising:
receiving a service start request that requests a start of a shipping service for shipping the cartridge for the printer;
receiving, from the printer, cartridge type information indicating a type of the cartridge mounted in the printer and cartridge remaining amount information indicating a remaining amount of the color material in the cartridge;
determining whether the cartridge mounted in the printer is a service available cartridge that is available for the shipping service based on the cartridge type information received from the printer, in a case where the service start request is received;
shipping a service available cartridge in a case where it is determined that the mounted cartridge is not the service available cartridge in the determining;
further determining whether a shipping condition is satisfied based on the received cartridge remaining amount information, in a case where it is determined that the mounted cartridge is the service available cartridge in the determining; and
shipping a service available cartridge in a case where it is determined that the shipping condition is satisfied in the further determining.

2. The non-transitory computer readable medium according to claim 1,
wherein a commercially available cartridge that is purchasable in a store, a packaged cartridge that is packaged with the printer when the printer is sold, and a service dedicated cartridge that is dedicated to the shipping service are mountable in the printer, and
the service available cartridge includes the packaged cartridge and the service dedicated cartridge.

3. A management method for a management system in which a printer to which a cartridge containing a color material is mountable and a management device are communicable with each other, the management method comprising:
receiving a service start request that requests a start of a shipping service for shipping the cartridge;
receiving, from the printer, cartridge type information indicating a type of the cartridge mounted in the printer and cartridge remaining amount information indicating a remaining amount of the color material in the cartridge;
determining whether the cartridge mounted in the printer is a service available cartridge that is available for the shipping service based on the cartridge type information received from the printer, in a case where the service start request is received;
shipping a service available cartridge in a case where it is determined that the mounted cartridge is not the service available cartridge in the determining;
further determining whether a shipping condition is satisfied based on the received cartridge remaining amount information, in a case where it is determined that the mounted cartridge is the service available cartridge in the determining; and
shipping a service available cartridge in a case where it is determined that the shipping condition is satisfied in the further determining.

4. A management method according to claim 3,
wherein a commercially available cartridge that is purchasable in a store, a packaged cartridge that is packaged with the printer when the printer is sold, and a service dedicated cartridge that is dedicated to the shipping service are mountable in the printer, and
the service available cartridge includes the packaged cartridge and the service dedicated cartridge.

5. A non-transitory computer readable medium storing a management program causing a controller to execute a process for controlling a management device of a management system in which a printer to which a plurality of color cartridges containing color material different to each other is mountable and the management device are communicable with each other, the process comprising:
receiving a service start request that requests a start of a shipping service for shipping the plurality of color material cartridges for the printer;
receiving, from the printer, color material cartridge type information indicating types of the color material cartridges mounted in the printer and color material cartridge remaining amount information indicating remaining amounts of the color materials in the color material cartridges;
determining whether at least one of the color material cartridges mounted in the printer is a service available cartridge available for the shipping service based on the received color material cartridge type information, in a case where the service start request is received;
shipping a service available cartridge containing a color material corresponding to one of the mounted color material cartridges in a case where it is determined that the one of the mounted color material cartridges is not the service available cartridge in the determining;
further determining whether a shipping condition for the one of the mounted color material cartridges is satisfied based on the received color material cartridge remaining amount information, in a case where it is determined that the one of the mounted color material cartridge is the service available cartridge in the determining; and
shipping a service available cartridge containing a color material corresponding to the one of the mounted color material cartridges in a case where it is determined that the shipping condition is satisfied in the further determining.

6. The non-transitory computer readable medium according to claim 5,
wherein the process further comprises starting a charging service for charging a fee for printing of the printer in a case where it is determined that all of the mounted color material cartridges are the service available cartridges in the determining.

7. The non-transitory computer readable medium according to claim 5,
wherein the process further comprises starting a charging service for charging a fee for printing of the printer in a case where it is determined that at least one of the mounted color material cartridges is the service available cartridge in the determining.

8. The non-transitory computer readable medium according to claim 5,
wherein the process further comprises shipping service available cartridges each of which contains a color material corresponding to the mounted color material cartridge in a case where it is determined that all of the plurality of mounted color material cartridges are not the service available cartridge in the determining.

9. A management method for a management system in which a printer to which a plurality of color material cartridges containing color materials different to each other are mountable and a management device are communicable with each other, the management method comprising:
receiving a service start request that requests a start of a shipping service for shipping the plurality of color material cartridges for the printer;
receiving, from the printer, color material cartridge type information indicating types of the color material cartridges mounted in the printer and color material cartridge remaining amount information indicating remaining amounts of the color materials in the color material cartridges;
determining whether at least one of the color material cartridges mounted in the printer is a service available cartridge available for the shipping service based on the received color material cartridge type information, in a case where the service start request is received;
shipping a service available cartridge containing a color material corresponding to one of the mounted color material cartridges in a case where it is determined that the one of the mounted color material cartridges is not the service available cartridge in the determining;
further determining whether a shipping condition for the one of the mounted color material cartridges is satisfied based on the received color material cartridge remaining amount information, in a case where it is determined that the one of the mounted color material cartridge is the service available cartridge in the determining; and
shipping a service available cartridge containing a color material corresponding to the one of the mounted color material cartridges in a case where it is determined that the shipping condition is satisfied in the further determining.

10. The management method according to claim 9 further comprising:
starting a charging service for charging a fee for printing of the printer in a case where it is determined that all of the mounted color material cartridges are the service available cartridges in the determining.

11. The management method according to claim 9 further comprising:
starting a charging service for charging a fee for printing of the printer in a case where it is determined that at least one of the mounted color material cartridges is the service available cartridge in the determining.

12. The management method according to claim 9 further comprising:
shipping service available cartridges each of which contains a color material corresponding to the mounted color material cartridge in a case where it is determined that all of the plurality of mounted color material cartridges are not the service available cartridge in the determining.
